(19) United States
(12) Patent Application Publication
(10) Pub. No.: US 2012/0060726 A1
(43) Pub. Date: Mar. 15, 2012

(54) Emergently Openable Safe Door

(75) Inventors: Yongyao Yao, Ningbo (CN); Jun Hu, Ningbo (CN); Zhongwei Cao, Ningbo (CN)

(73) Assignee: NINGBO YONGFA GROUP CO., LTD.,, Ningbo, Zhejiang (CN)

(21) Appl. No.: 13/321,555

(22) PCT Filed: May 21, 2010
(86) PCT No.: PCT/CN2010/000725

§ 371 Date: Nov. 21, 2011

(30) Foreign Application Priority Data
May 22, 2009 (CN) 200910098946.5

(51) Int. Cl. E05G 1/04

(52) U.S. Cl. 109/63.5

(57) ABSTRACT

An emergently openable safe door having a mechanic lock and an electronic lock. The mechanic lock has a shell and a cylindrical plug in the shell. The plug has a primary keyway for a primary key and an emergent keyway for an emergent key. The mechanic lock and an electric lock are able to respectively be opened with a primary key and enter cod normally and be opened with the primary key and a emergent key emergently when the electronic lock thereof malfunctions or an enter code thereof is forgotten.

### CROSS-REFERENCE TO RELATED APPLICATIONS

This is a Continuation-In-Part application of U.S. patent application Ser. No. 13/321,549.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The invention relates to an emergently openable safe door, and more particularly, to a safe door having a primary key for normal open and a emergent key for emergent open when an electronic lock thereof malfunctions or an enter code thereof is forgotten.

2. Description of Related Art

A conventional pin tumbler lock usually has a shell having formed therein a central cylindrical opening in which is located a plug. The shell further has formed therein a set of chambers, each of which is a radially extending bore adapted to receive therein a pin stack which includes a compression spring, a driver pin, and a key pin. The key pin is outermost, and is supported on the driver pin, which is seated in turn on the compression spring, which assists in forcing the key pin across a shear line and into the keyway formed in the plug, so as to block rotation thereof within the cylinder. In this position, the lock cannot be opened without a key. The driver pins are of uniform length, while the key pins are of different lengths.

A conventional safe door always has a pin tumbler lock and an electronic lock having a keypad and an enter code. The safe door will need an emergent open when the electronic lock malfunctions or the code thereof is forgotten. Chinese patent ZL2004200817.4 discloses a safe with an emergent lock. The safe has an emergent lock independent from a main pin tumbler mechanic lock thereof. The emergent lock has a special emergent key which can be used to mechanically open an electronic lock of the safe when the electronic lock malfunctions or the enter code is forgotten.

However if the emergent key is actually used, an operation of the key for the main mechanic lock and the emergent lock are complex: it needs two hands to rotate the keys or rotate the keys one by one with one hand. And nearly two whole sets of mechanic locks will increase a weight of the safe door.

### BRIEF SUMMARY OF THE INVENTION

The main object of the invention is to provide an emergently openable safe door having a mechanic lock and an electric lock which are able to respectively be opened with a primary key and enter cod normally and be opened with the primary key and a emergent key emergently when the electronic lock thereof malfunctions or an enter code thereof is forgotten.

In order to achieve above object, the invention provides an emergently openable safe door having a door panel having a slide plate, at least one bolt connected to the slide plate, a swing handle rotatably installed on the door panel, a handle sheet fixed to the swing handle and being able to transversely drive the slide plate, an electronic lock installed on the door panel having a keypad on a front face of the door panel, a magnetic valve fixed on a rear face of the door panel having a core slidably contained therein, and a mechanic lock installed on the door panel. The mechanic lock has a shell and a cylindrical plug in the shell. The plug has a primary keyway for a primary key and an emergent keyway for an emergent key. At least one set of primary pin stack and at least one set of emergent pin stack are provided between the shell and the plug, respectively coupling with the primary and the emergent keys. Each set of the primary and the emergent pin stack has a compression spring, a driver pin, and a key pin. The key pin is outermost and is supported on the driver pin, which is seated on the compression spring, which assists in forcing the key pin across a shear line and into the keyway formed in the plug. A longitudinal stage is formed on a cylindrical surface of the plug. An involute side face extends from the stage to the cylindrical surface of the plug. A core blocking plate is provided transversely slidable with the door panel which is able to block the core and release the core when the primary key is inserted in the primary keyway and rotated. A primary pick is provided fixing on the plug having two ends of which when the primary key is inserted in the primary keyway and rotated, one end is able to release the slide plate and another is able to activate the magnetic valve to release the core. An emergent pick is provided fixing on the plug having one end which, when the emergent key is inserted in the emergent keyway and rotated together with the primary key, is able to press the core of the magnetic valve to mechanically release the electronic lock.

These and other objectives, features, and advantages of the present invention will become apparent from the following detailed description, the accompanying drawings, and the appended claims.

### BRIEF DESCRIPTION OF THE SEVERAL VIEWS OF THE DRAWINGS

FIG. 1 is a schematic plane view of the preferred embodiment of an emergently openable safe door of the invention when the lock is in a status of being locked.

FIG. 2 is a left side view thereof.

FIG. 3 is another plane view thereof when the lock is in a status of normally open.

FIG. 4 is a cross-sectional view of a mechanic lock thereof.

FIG. 5 is a cross-sectional view along A-A line in FIG. 4.

FIG. 6 is a left side view of FIG. 4.

FIG. 7 is a cross-sectional view of the mechanic lock in normal open.

FIG. 8 is a cross-sectional view along B-B line in FIG. 7.

FIG. 9 is a left side view of FIG. 7.

FIG. 10 is a cross-sectional view of the mechanic lock in emergent open.

FIG. 11 is a cross-sectional view along C-C line in FIG. 10.

FIG. 12 is a left side view of FIG. 10.

FIG. 13 is a cross-sectional view of a plug of the invention.

FIG. 14 is a cross-sectional view along D-D line in FIG. 13.

FIG. 15 is a cross-sectional view along E-E line in FIG. 13.

FIG. 16 is a left side view of FIG. 13.

FIG. 17 is a right side view of FIG. 13.

FIG. 18 is a plane view of a primary key of the invention.

FIG. 19 is a plane view of a emergent key of the invention.

FIG. 20 is a plane side view of a primary pick of the invention.

FIG. 21 is another plane side view of the primary pick of the invention. And,

FIG. 22 is a plane side view of a emergent pick of the invention.

### DETAILED DESCRIPTION OF THE INVENTION

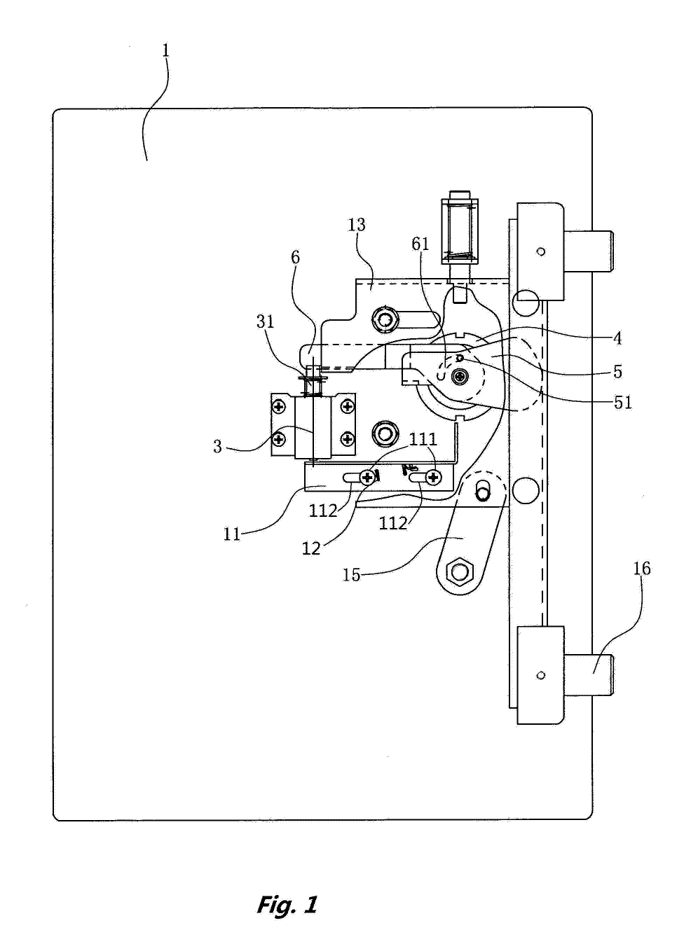

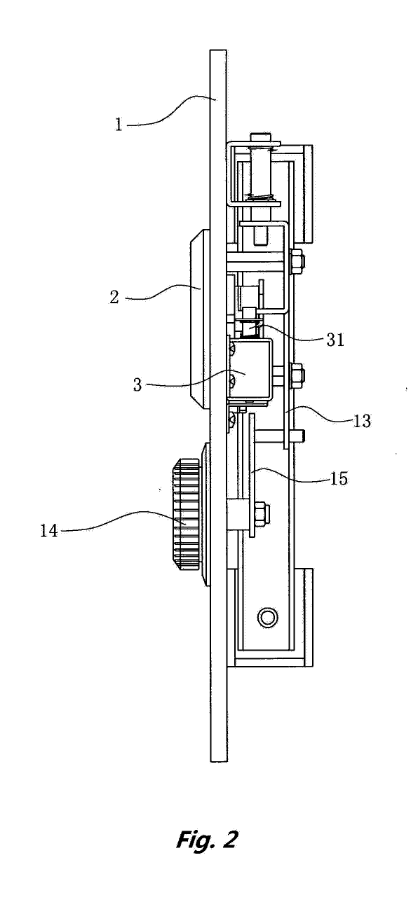

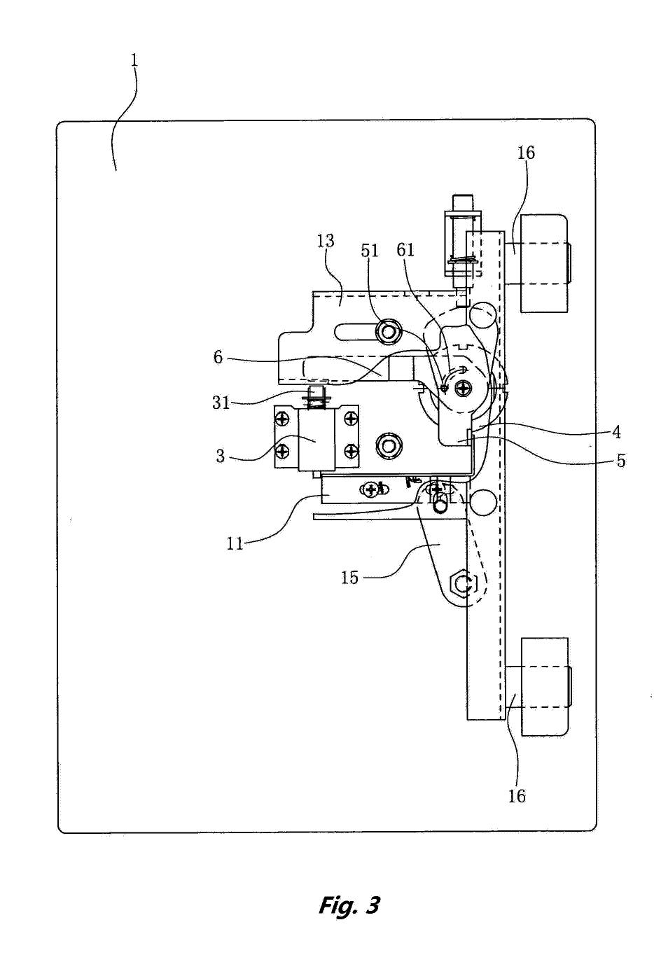

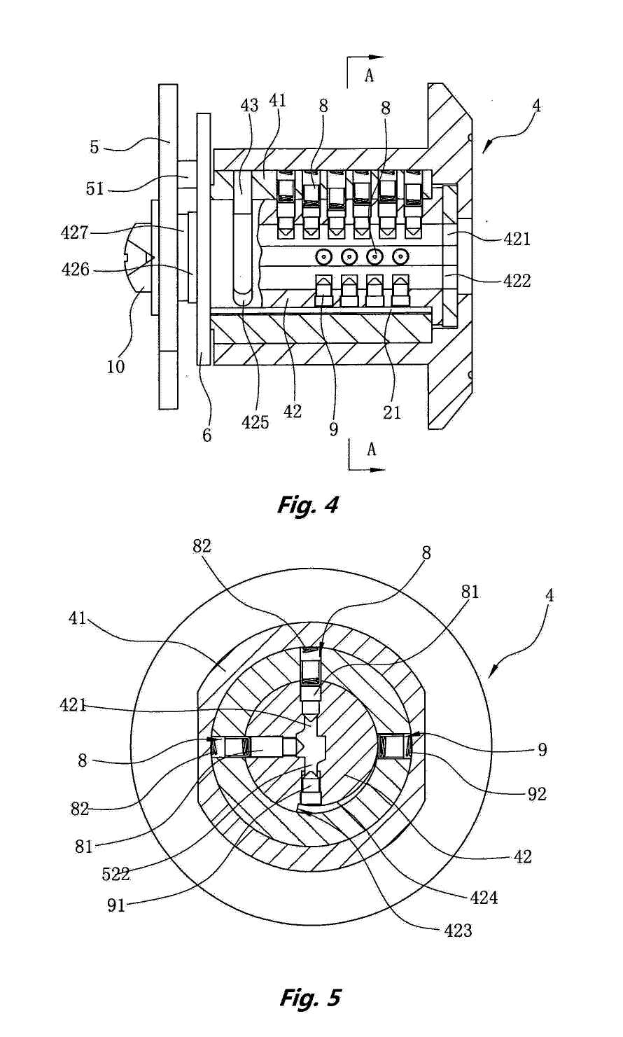

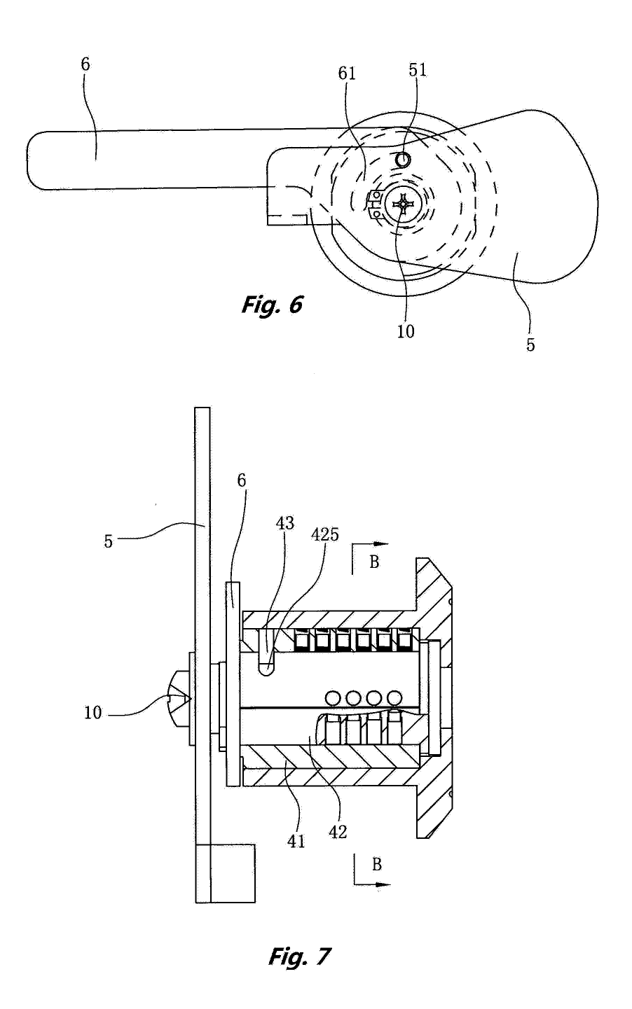

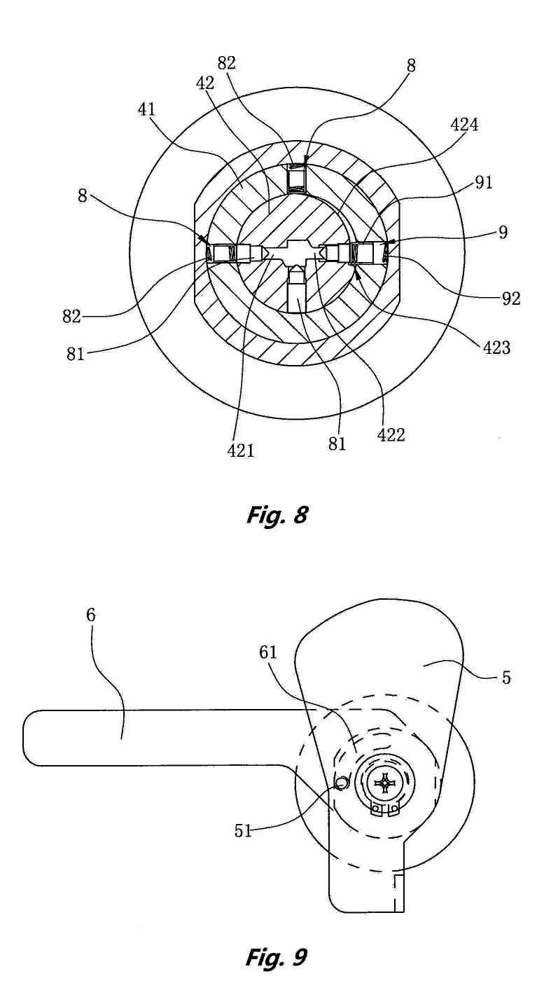

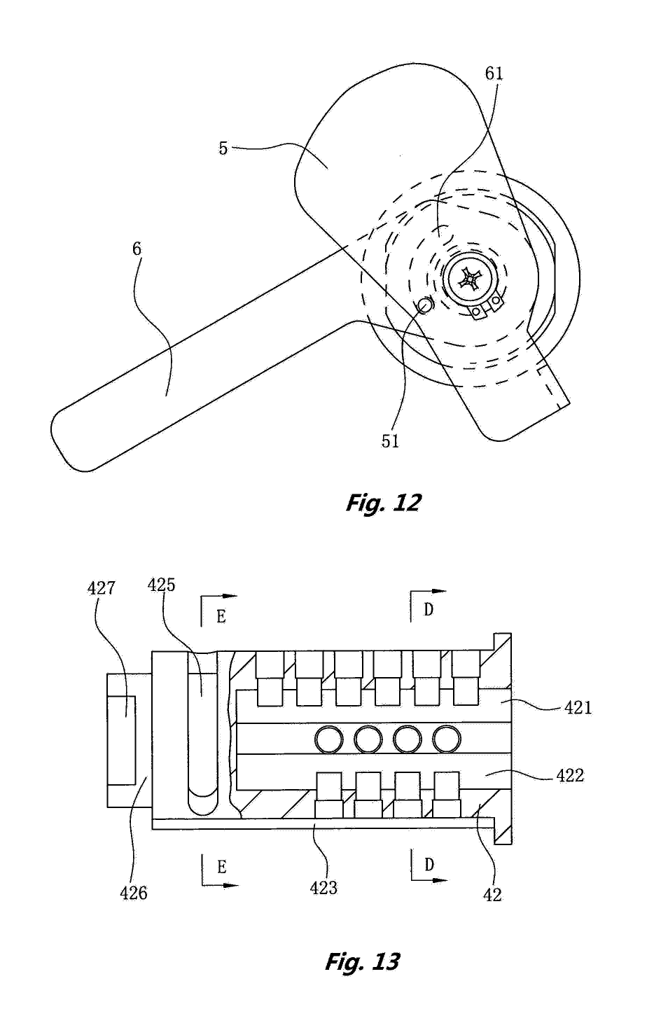

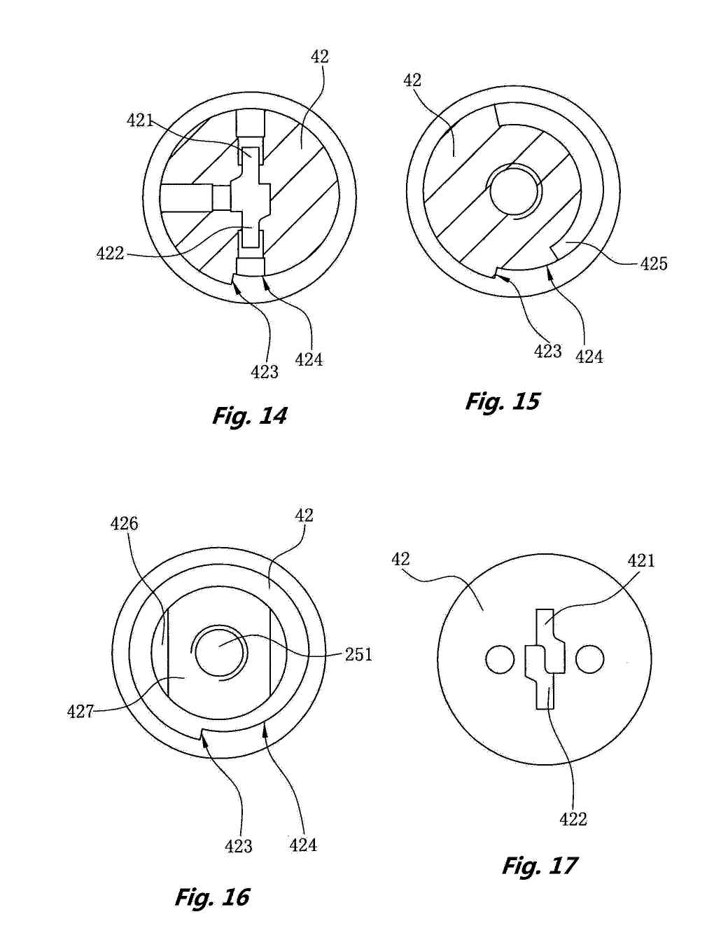

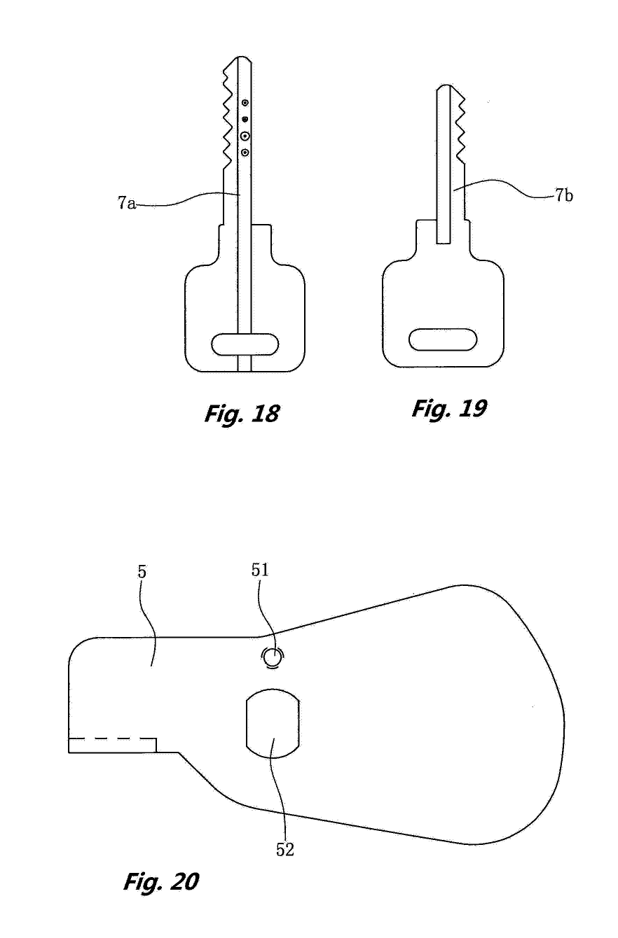

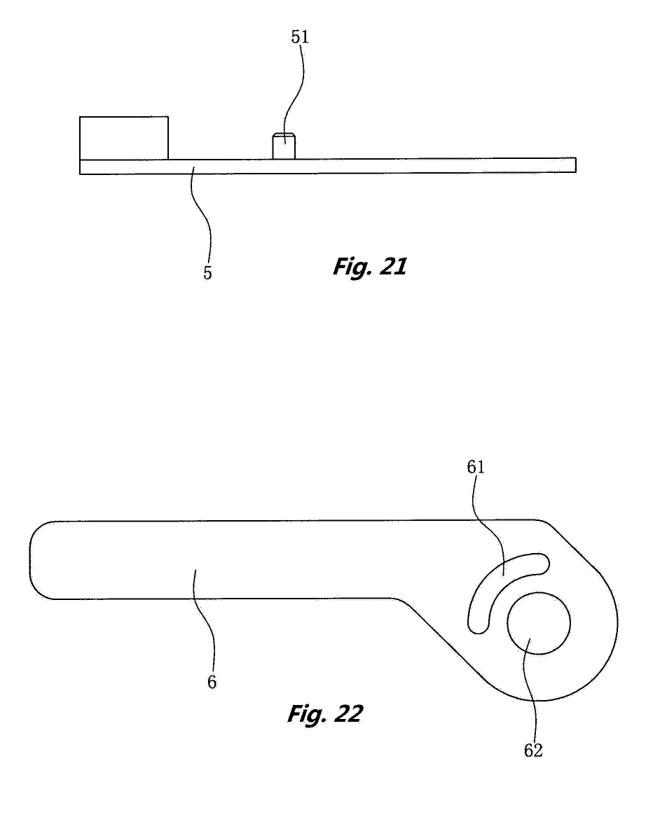

With reference to FIGS. 1 through 22, the preferred embodiment of an emergently openable safe door of the invention is shown. The safe door has a door panel 1 having a slide plate 13, at least one bolt 16 connected to the slide plate 13, a swing handle 14 rotatably installed on the door panel 1, a handle sheet 15 fixed to the swing handle 14 and being able to transversely drive the slide plate 13.

The safe door further has an electronic lock 2 installed thereon. A keypad of the electronic lock 2 is on a front face of the door panel 1.

The safe door further has a magnetic valve 3 fixed on a rear face of the door panel 1 and slidably containing a core 31 therein. The magnetic valve 3 is controlled by the electronic lock 2. When the electronic lock is locked, the core 31 engages the slide plate 13, making the slide plate 13 transversely stable. And when an enter code of the electronic lock 2 is correctly entered, the core 31 is released by the magnetic valve 3 and able to slide with respect to the magnetic valve 3 to disengage the slide plate 13. The structure and work of the slide plate 13, bolt 16, swing handle 14, handle sheet 15, electronic lock 2, magnetic valve 3 and the core 31 are conventional and will not be described here in detail.

The safe door further has a mechanic lock 4 installed on the door panel 1. The mechanic lock 4 has a shell 41 and a cylindrical plug 42 in the shell 41. The plug 42 has a primary keyway 421 for a primary key 7a and an emergent keyway 422 for an emergent key 7b. As particularly shown in FIG. 17, the primary and the emergent keyways 421 and 422 are contiguous in this preferred embodiment. They are able to be separate with each other in the plug 42.

At least one set of primary pin stack 8 and at least one set of emergent pin stack 9 are provided between the shell 41 and the plug 42, respectively coupling with the primary and the emergent keys 7a and 7b. There are two sects of primary pin stack 8 and one set of emergent pin stack 9 in this preferred embodiment and there might be more than this quantity. Each set of the primary and the emergent pin stacks 8 or 9 has a compression spring 82 or 92, a driver pin 83 or 93, and a key pin 81 or 91. The key pin 81 or 91 is outermost and is supported on the driver pin 83 or 93, which is seated on the compression spring 82 or 92, which assists in forcing the key pin 81 or 91 across a shear line and into the keyways 421 or 422 formed in the plug 42. A structure and working of the sets of pin stacks 8 and 9 are as same as the conventional pin tumbler locks and will not be discussed here in detail.

There is a longitudinal stage 423 formed on a cylindrical surface of the plug 42. An involute side face 424 extends from the stage 423 to the cylindrical surface of the plug 42. The involute side face 424 may cover about, preferably, 90 degree.

When inserted in the primary keyway 421, the primary key 7a is able to unlock the plug 42 from the shell 41 by the primary pin stacks 8, making a rotation of the primary key 7a be able to drive the plug 42 to rotate with respect to the shell 1 to a position of primary open until the stage 423 meets and is stopped by the key pin 91 of the emergent pin stacks 9.

In the position of primary open when the stage 423 is blocked by the key pin 91 of the emergent pin stacks 9, the emergent key 7b is able to be inserted in the emergent keyway 422. The emergent key 7b is able to unlock the plug 42 from the shell 41 by the emergent pin stacks 9. When the primary and the emergent keys 7a and 7b are rotate at this same time, the plug 42 is able to rotate with respect to the shell 41 to a position of emergent open.

An emergent shaft 426 is formed on an inner end of the plug 42 and a primary shaft 427 is formed on a free end of the emergent shaft 427. An emergent pick 6 is provided having a hole 62 slidably covering on the emergent shaft 426 and a primary pick 5 is provided having a profile hole 52 fixedly covering on the primary shaft 427. A screw hole is defined in a side surface of the primary shaft 427. A screw 10 is able to insert in the screw hole to limit the primary pick 5 from falling off from the primary shaft 427. A driving pillar 51 is formed on the primary pick 5 and slidably contained in an arc-shaped guiding groove 61 defined in the emergent pick 6. The guiding groove 61 has two ends and a degree of an arc thereof is as same as the degree the plug 42 rotates from the locked position to the primary open position. The rotation of the emergent pick 6 is able to push the core 31 of the magnetic valve 3.

A cross groove 425 is defined in the cylindrical surface of the plug 42 and a pin 43 is formed on an inner surface of the shell 41 and slidably contained in the cross groove 425. A movement of the pin 43 is limited by two ends of the cross groove 425, which are respectively corresponding to a locked position and emergent open position of the plug 42 with respect to the shell 41.

A core blocking plate 11 is provided on the rear face of the door panel 1 which is able to transversely slidable with respect to the door panel 1. In the locked position, the core blocking plate 11 is under the core 31 to prevent the core 31 to move downward. A spring 12 is provided between the door panel 1 and the core blocking plate 11, for keeping the core blocking plate 11 in a constant position under the core 31. The rotation of the primary pick 5 is able to drive the core blocking plate 11 to transversely move towards the bolt 16 to leave the core 31. The core blocking plate 11 is slidably installed on the rear face of the door panel 1 with two positioning screws 111 being slidably contained in two level slits 112.

In a normal open process as shown in FIGS. 1, 7, 8 and 9, the primary key 7a is able to be inserted into the primary keyway 421. The primary key 7a will push the key pin 81 of the primary pin stacks 8 to the shear line and unlock the plug 42 with respect to the shell 41. When the primary key 7a is rotated, the plug 42 and the primary pick 5 rotate accordingly. One end of the primary pick 5 leaves the slide plate 13 and another end thereof meets and then drives the core blocking plate 11 to leave the core 31 against the spring 12. After a rotation of preferably 90 degree as in this embodiment, the stage 423 meets the key pin 91 of the emergent pin stacks 9 and the plug 42 stops. In this process, the plug 42 rotates with respect to the emergent pick 6. The driving pillar 51 of the primary pick 5 freely slides along the guiding groove 61 of the emergent pick 6 until meet two ends of the guiding groove 61. In a position of locked, the primary pick 5 is able to block a slide plate of a safe to lock a bolting mechanism thereof. In a position of primary open, the primary pick 5 release the slide plate to open the bolting mechanism of the safe. In the normal open process, only the primary pick 5 rotates and the emergent pick 6 keeps stable. At this time, if then enter code of the electronic lock 2 is correctly entered, the magnetic valve 3 is actuated and the core moves downward. Then when the swing handle 14 is rotated, the handle sheet 15 will drive the slide plate 13 and the bolt 16 to move backward and the safe door will be able to be opened.

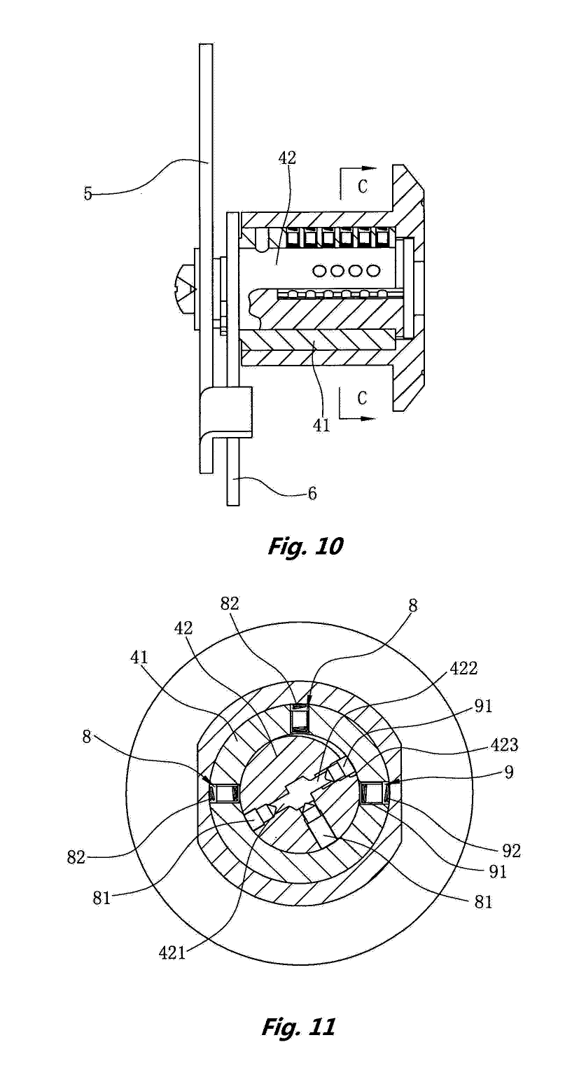

In an emergency open as the electronic lock 2 of the safe malfunctions or the enter code thereof is forgotten, as shown in FIGS. 10 through 12, the emergent key 7b is able to be inserted into the emergent keyway 422 together with the primary key 7a in the primary keyway 421. the key pin 91 of the emergent pin stacks 9 is pushed to the shear line by the emergent key 7b to unlock the stage 423. Rotate the primary and the emergent keys 7a and 7b together, the plug 42 will be able to rotate further from the position of primary open. The driving pillar 51 of the primary pick 5 will drive the emergent pick 6 to rotate until an end of the cross groove 425 meets and is stopped by the pin 43 of the shell 41. In this emergent open, emergent pick 6 touches and drives the core 31 to move downward. The core 31 will no longer block the slide plate 13 to move backward. The electronic lock 2 is thus mechanically unlocked and when the swing handle 14 is rotated, the safe door will be opened. Either the primary key 7a or the emergent key 7b cannot open the safe door individually if the electronic lock 2 of the safe door malfunctions or the enter code thereof is forgotten. A reverse operation will able to lock the safe door.

From above description, it is seen that the objects of the present invention have been fully and effectively accomplished. Embodiment of the invention has been shown and described for the purposes of illustrating the functional and structural principles of the present invention and is subject to change without departure from the invention's principles. Therefore, this invention includes all modifications encompassed within the spirit and scope of the following claims.

1. An emergently openable safe door comprising:
a door panel having a slide plate, at least one bolt connected to the slide plate, a swing handle rotatably installed on the door panel, a handle sheet fixed to the swing handle and being able to transversely drive the slide plate, an electronic lock installed on the door panel having a keypad on a front face of the door panel, a magnetic valve fixed on a rear face of the door panel having a core slidably contained therein, and a mechanic lock installed on the door panel, wherein the mechanic lock has a shell and a cylindrical plug in the shell, the plug has a primary keyway for a primary key and an emergent keyway for an emergent key, at least one set of primary pin stack and at least one set of emergent pin stack are provided between the shell and the plug, respectively coupling with the primary and the emergent keys, each set of the primary and the emergent pin stack has a compression spring, a driver pin, and a key pin, and the key pin is outermost and is supported on the driver pin, which is seated on the compression spring, which assists in forcing the key pin across a shear line and into the keyway formed in the plug, a longitudinal stage is formed on a cylindrical surface of the plug, an involute side face extends from the stage to the cylindrical surface of the plug, a core blocking plate is provided transversely slidable with the door panel which is able to block the core and release the core when the primary key is inserted in the primary keyway and rotated, a primary pick is provided fixing on the plug having two ends of which when the primary key is inserted in the primary keyway and rotated, one end is able to release the slide plate and another is able to activate the magnetic valve to release the core, an emergent pick is provided fixing on the plug having one end which, when the emergent key is inserted in the emergent keyway and rotated together with the primary key, is able to press the core of the magnetic valve to mechanically release the electronic lock.

2. The emergently openable safe door as claimed in claim 1, wherein the involute side face covers about 90 degree.

3. The emergently openable safe door as claimed in claim 1, wherein the core blocking plate is slidably installed on the rear face of the door panel with two positioning screws being slidably contained in two level slits defined therein.

4. The emergently openable safe door as claimed in claim 1, wherein an emergent shaft is formed on an inner end of the plug and a primary shaft is formed on a free end of the emergent shaft, the emergent pick has a hole slidably covering on the emergent shaft and the primary pick has a profile hole fixedly covering on the primary shaft, a screw hole is defined in a side surface of the primary shaft, a screw is insert in the screw hole to limit the primary pick from falling off from the primary shaft, and, a driving pillar is formed on the primary pick and slidably contained in an arc-shaped guiding groove defined in the emergent pick.

5. The emergently openable safe door as claimed in claim 1, wherein a cross groove is defined in a cylindrical surface of the plug and a pin is formed on an inner surface of the shell and slidably contained in the cross groove.
